(19) United States
(12) Patent Application Publication
(10) Pub. No.: US 2008/0064400 A1
(43) Pub. Date: Mar. 13, 2008

(54) Method for detection and recovery from wireless signal interference

(76) Inventors: David S. Benco, Winfield, IL (US); Sanjeev Mahajan, Naperville, IL (US); Baoling S. Sheen, Naperville, IL (US); Sandra Lynn True, St. Charles, IL (US)

Correspondence Address: Lucent Technologies Inc.,;Docket Administrator, Room 3J-219, 101 Crawfords Corner Road, Holmdel, NJ, 07733-3030, US

(21) Appl. No.: 11/520,547

(22) Filed: Sep. 13, 2006

(51) Int. Cl. H04Q 7/20

(52) U.S. Cl. 455/436

(57) ABSTRACT

Methods are disclosed for detecting and recovering from incidents of wireless signal interference that threaten to disable or disrupt wireless telephone services. Mobile units that are engaged in active calls that are compromised due to incidents of wireless signal interference are instructed to retune to an alternate channel. If the mobile successfully receives the retune message, it performs a handoff to the alternate channel and the call remains active. Otherwise, the call will be dropped or suspended. For a period of time following incidents of interference, affected channels are rendered unavailable for new call originations, terminations, handoffs or reconnects; however, the channels may be redesignated as available if sufficient time elapses without any further incidents of wireless signal interference.

### FIELD OF THE INVENTION

This invention relates generally to wireless communication systems, and, more particularly, to methods for detecting and recovering from wireless signal interference that may impair or disable available wireless resources.

### BACKGROUND OF THE INVENTION

Wireless communication systems are well known in which mobile units can initiate or receive calls while roaming between different radio frequency (RF) coverage areas (sometimes referred to as “cells”). The mobile units communicate via RF resources with base stations distributed among the cells, which base stations are controlled by one or more mobile switching centers (MSCs). The MSCs provide control signaling for the call and connect the mobile unit to other participating endpoints, which may comprise other mobile units or wireline units.

Unfortunately, wireless communication systems are vulnerable to wireless signal interference such as may caused, for example, by frequency jamming or even inadvertent signal interference. This is problematic, most particularly during periods of network congestion when there is a high demand for wireless resources. In emergency situations, for example, a relatively simple jamming device can temporarily impair or disable the available resources thereby exacerbating a crisis situation. It is contemplated that jamming transmissions may be experienced over a range of RF resources, for example, through use of multiple jamming transmitters or by a single jamming transmitter progressively advancing through multiple frequencies/channels in an attempt to achieve greatest disruption of the available resources.

Although jamming devices are illegal, they are manufactured off-shore and are available for purchase in the United States and many other countries. While most of the devices are low-powered (i.e., having an effective range of a few hundred feet), it is straightforward to produce higher-power devices (i.e., having a range of tens of miles) capable of impairing or disabling up to hundreds or thousands of mobile units at least temporarily.

Generally, the level of impairment produced by wireless signal interference due to jamming or other sources can vary depending on the strength and duration of the interference, and may or may not result in service interruptions (e.g., dropped calls). For calls that remain active during incidents of wireless signal interference, methods do not exist for the network to detect and recover from the interference while continuing the active call (i.e., the network will not attempt to reconnect the user unless and until the call is dropped). Moreover, methods are not known to manage channel assignments following incidents of wireless signal interference for reconnects, new originations, terminations or handoffs (i.e., to block channels during periods of existing or prospective interference and to make affected channels available upon recovery from the interference).

### SUMMARY OF THE INVENTION

These problems are addressed and a technical advance is achieved in the art by a feature whereby wireless networks can detect and recover from incidents of wireless signal interference that occur during active calls; and manage channel assignments for reconnections, new originations/terminations or hand-offs following incidents of wireless signal interference.

In one embodiment, there is provided a method for accommodating incidents of wireless signal interference occuring during active calls. Upon detecting an incident of jamming or other signal interference that compromises a wireless channel during an active call, mobile units tuned to the compromised channel are instructed to retune/handoff to an alternate channel. If the mobile unit responds to the retune message before expiration of a waiting period, a hand-off is performed to an alternate wireless channel. Otherwise, if the mobile unit does not respond, the call is ended (or alternatively, suspended).

In another embodiment, there is provided a method for managing channel assignments for reconnections, new originations/terminations or hand-offs following incidents of wireless signal interference. Upon detecting an incident of jamming or other signal interference corresponding to an available wireless channel, the channel is rendered unavailable for a designated time period for reconnections, new originations/terminations or hand-offs. If the predetermined time period elapses without any further incidents of wireless signal interference corresponding to the channel, the channel is re-designated as available.

### BRIEF DESCRIPTION OF THE DRAWINGS

The foregoing and other advantages of the invention will become apparent upon reading the following detailed description and upon reference to the drawings in which:

FIG. 1 is a block diagram of a communication system according to an exemplary embodiment of the present invention, illustrating an incident of wireless signal interference due to jamming;

FIG. 2 is a state diagram illustrating various call states supported by a communication system of the type shown in FIG. 1 according to an embodiment of the present invention;

FIG. 3 is a flowchart showing a method for use in conjunction with a communication system of the type shown in FIG. 1, for accommodating incidents of wireless signal interference occurring during active calls; and

FIG. 4 is a flowchart showing a method for use in conjunction with a communication system of the type shown in FIG. 1, for managing channel assignments for reconnections, new originations/terminations or hand-offs following incidents of wireless signal interference.

### DESCRIPTION OF THE PREFERRED EMBODIMENT(S)

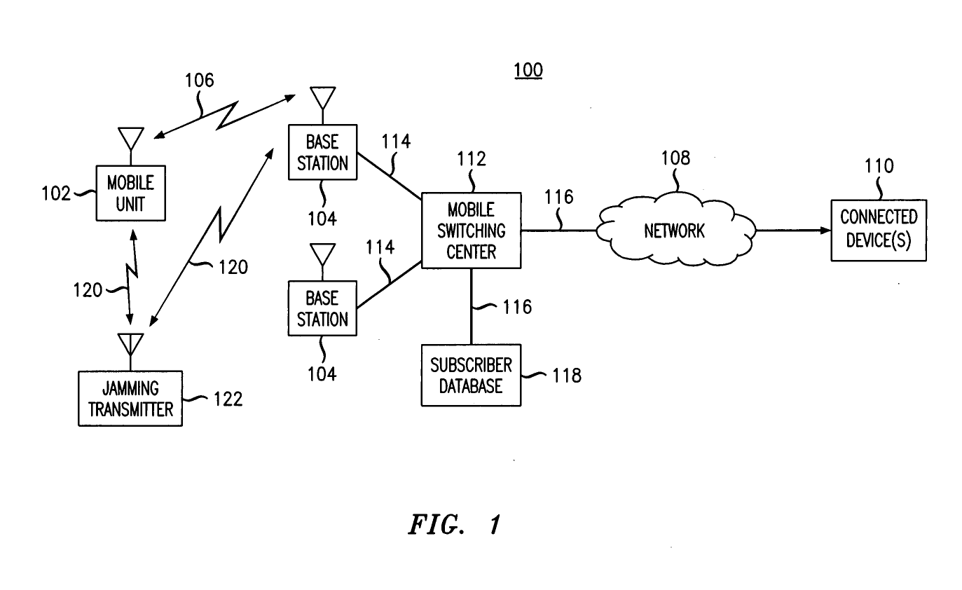

FIG. 1 illustrates an exemplary wireless communication system 100 undergoing wireless signal interference due to jamming. The wireless communication system 100 may comprise a public or private system, or a combination thereof. Distributed among the communication system 100 is a plurality of mobile units 102 (one shown). The mobile units 102 comprise wireless devices that may include, but are not limited to, cell phones, two-way radios, laptop computers, personal digital assistants (PDAs) and the like having varying capacities to transmit information, such as voice, video, text or data traffic (“payload information”) or control signaling (“control information”) associated with communication service(s). The communication services may comprise, for example, wireline or wireless telephone service, electronic mail, facsimile service, paging service, short message service, electronic commerce, location service and/or packet data service.

The mobile units 102, generally, are adapted to roam between different RF coverage areas, sometimes referred to as “cells” (not shown) served by base stations 104 (two shown). The mobile units 102 communicate with the base stations 104 via RF resources 106 which may comprise narrowband frequency modulated channels, wideband modulated signals, broadband modulated signals, time division modulated slots, carrier frequencies, frequency pairs or generally any medium for communicating control or payload information to and from the mobile units. The RF resources may implement air interface technologies including but not limited to, CDMA, TDMA, GSM, UMTS or IEEE 802.11.

The mobile units 102 are linked via network 108 with one or more connected devices 110 (one shown) such as other mobile units or wireline devices residing within the wireless communication system 100 or within external communication systems. The network 108 may be implemented using any appropriate transmission, switching and routing technologies, as are known in the art, including but not limited to Internet Protocol (IP) and Asynchronous Transfer Mode (ATM) technologies.

Wireless calls between and among the mobile units 102 and connected devices 110 are controlled by one or more telecommunication switching systems, exchanges or the equivalent (one shown), hereinafter termed a mobile switching center (MSC) 112. The MSC 112 may comprise, for example, an AUTOPLEX™ switching system, available from Lucent Technologies, Inc. The MSC 112 includes memory and processors (not shown), for storing and executing software routines for processing and switching calls, for providing various call features to calling parties and for providing access to the network 108. The MSC 112 may be configured for operation with generally any suitable circuit, cell, or packet switching technology.

The MSC 112 is connected to the base stations 104 by links 114, which may comprise, without limitation, Asynchronous Transfer Mode (ATM) links, ISDN lines, Ethernet LAN, wireless links, and the like. Links 116 carry control and payload information between the MSC 112 and the network 108 and, as shown, between the MSC 112 and a database 118 (e.g., a subscriber database). Although the links 116 are depicted with singular lines, the links 116 are logical links that may be physically realized by multiple physical lines or wireless links.

In the exemplary embodiment of FIG. 1, it is presumed that the MSC 112 has established a call between mobile unit 102 and one or more connected devices 110 and, sometime during the call, encounters wireless signal interference 120. As shown, the wireless signal interference 120 is produced intentionally by a jamming transmitter 122. Generally, however, wireless signal interference may occur intentionally or inadvertently resulting from one or more known or unknown sources.

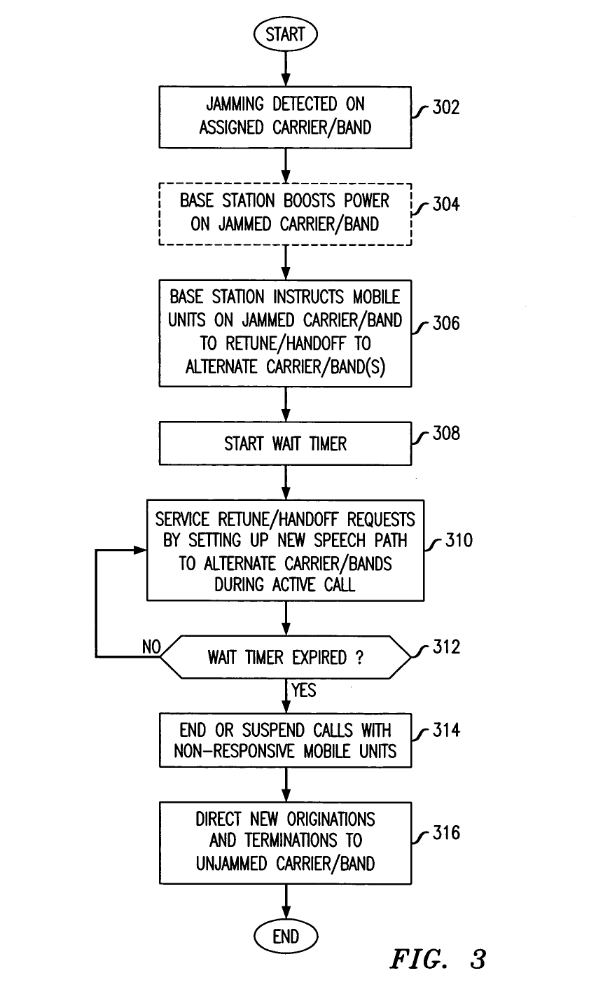

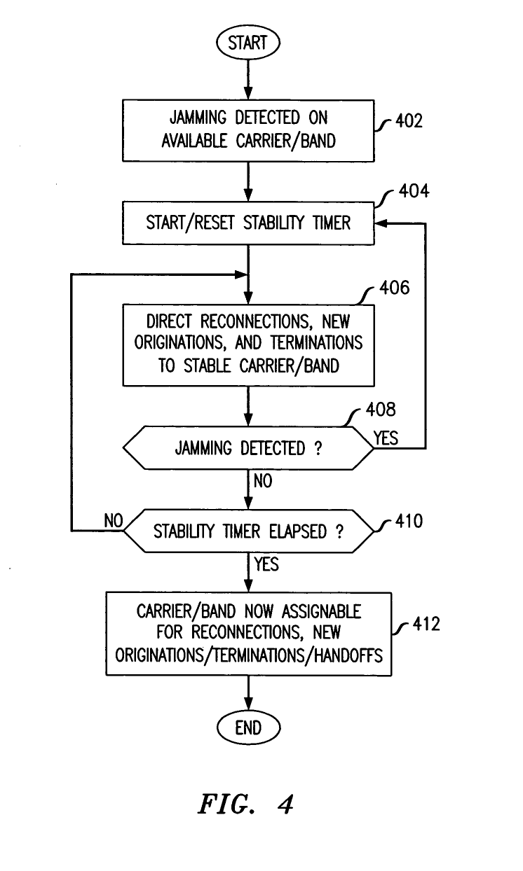

As noted previously, the level of impairment produced by wireless signal interference due to jamming or other sources can vary depending on the strength and duration of the interference, and may or may not result in service interruptions (e.g., dropped calls). Thus, in the exemplary embodiment of FIG. 1, the wireless signal interference may or may not result in mobile unit 102 being dropped from its call. As will be described in greater detail in relation to FIGS. 3 and 4, the present invention provides a method for the network to detect and recover from the wireless signal interference whether the mobile unit 102 remains connected or is dropped from the original call.

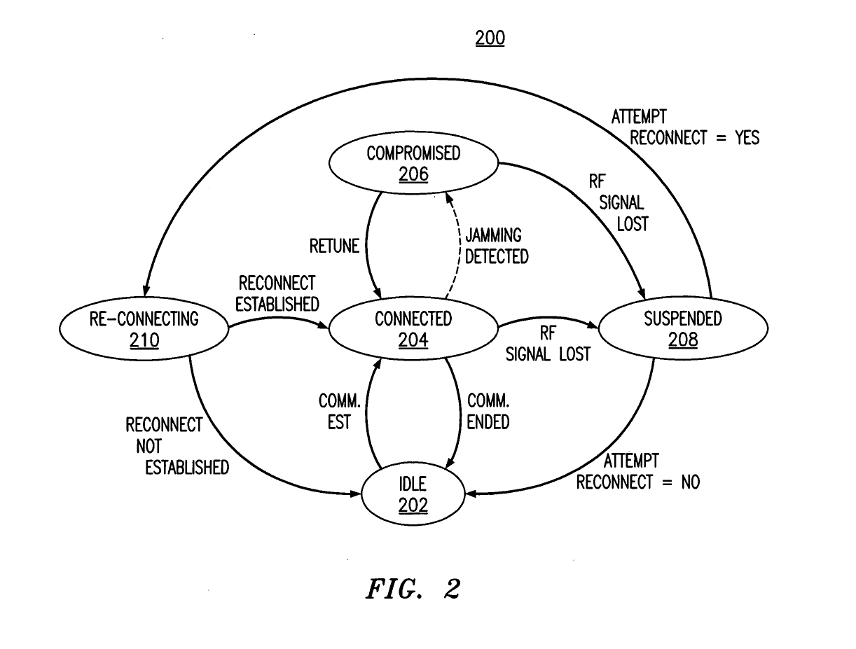

FIG. 2 is a state diagram 200 illustrating various call states supported by a communication system of the type shown in FIG. 1. The call states include an IDLE state 202, CONNECTED state 204, COMPROMISED state 206, SUSPENDED state 208 and RECONNECTING state 210. Each mobile unit having registered with an MSC occupies one of the call states, but the mobile units may occupy different call states at different times. In one embodiment, each individual mobile unit keeps track of its present call state; and the respective call states of one or more mobile units are also tracked by serving MSCs (i.e., the MSCs serving the respective locations of the mobile units). In one embodiment, state machines and/or memory residing within the mobile units and MSCs record the various call states. Alternatively or additionally, state machines and/or memory recording call states of the mobile units may reside in separate network elements in communication with the MSCs.

Generally, a mobile unit is in the IDLE state 202 when it is not presently engaged in a call involving other connected units. That is, a mobile unit in the IDLE state does not presently require a bearer channel (e.g., voice channel) to support a call. Nevertheless, in the IDLE state, the mobile unit may communicate control messages with a serving MSC for mobility management purposes and the like.

A mobile unit enters the CONNECTED state 204 from the IDLE state 202 when it initiates or receives a call and a bearer channel is established to support the call. Typically, the mobile unit remains in the CONNECTED state for so long as it continues to participate in the call. If the mobile unit voluntarily ends its participation in the call, the call state moves from the CONNECTED to the IDLE state. If the bearer channel or control channel is impaired during the call but the impairment does not cause the mobile unit to lose RF coverage (as might occur, for example, during inadvertent signal interference or a relatively low-power or low-duration jamming transmission), the call state moves from the CONNECTED to the COMPROMISED state 206.

While in the COMPROMISED state, the mobile unit is still able to participate in the call (albeit at an impaired level due to signal interference) and other connected parties still have bearer channels connected to the call (i.e., remaining in the CONNECTED state). As will be described in greater detail in relation to FIG. 3, an embodiment of the present invention provides for the network to recognize when a mobile unit is in a COMPROMISED state and instruct the mobile unit to retune to an unimpaired channel. Alternatively, the mobile unit itself may initiate a retune to an unimpaired channel. In either case, if the mobile unit successfully retunes to an unimpaired channel, the call state returns to the CONNECTED state.

If the bearer channel to the mobile unit is interrupted during the call (i.e., the mobile unit loses RF communication with its base station), the call state moves from the CONNECTED or COMPROMISED state to the SUSPENDED state 208. While in the SUSPENDED state, the mobile unit has lost (at least temporarily) the ability to participate in the call; and the network or the user may initiate a reconnect attempt. If a reconnect is attempted, the call state moves from the SUSPENDED state to the RECONNECTING state 210 and an attempt is made to reconnect the mobile to the suspended session. As will be described in greater detail in relation to FIG. 4, an embodiment of the present invention provides for the network to monitor incidents of signal interference and assign new channels for reconnects, new originations or terminations on stable frequencies/bands (i.e., that have not been subject to interference for a designated time). If the reconnect is established, the call state returns to the CONNECTED state and the call may resume with the original parties on a stable channel. If the reconnect is not attempted or is not established within a designated time period, the call state returns to the IDLE state 202.

FIG. 3 is a flowchart showing a method for accommodating incidents of wireless signal interference occurring during active calls. The steps of FIG. 3 are implemented, where applicable, using stored software routines within base station 104, MSC 112 and/or mobile unit 102.

At step 302, jamming or other wireless signal interference is detected on a wireless channel (e.g., carrier/band) supporting an active call. That is, the jamming or other interference has a frequency, intensity or other physical characteristic that creates channel impairments so as to compromise RF communications between a mobile unit and base station on the assigned wireless channel. In one embodiment, the signal interference is detected, initially, by base station(s) of the cell/sector(s) in which affected mobile units are registered (e.g., upon RF loading exceeding a system-defined threshold) and the incident is reported to the serving MSC. At such time, the MSC and base station will consider mobile unit(s) using the compromised channel to be in the COMPROMISED state. The jamming or other signal interference may or may not result in loss of RF communication between the mobile unit and base station, and indeed the base station may not know (at least initially) whether the signal interference causes a loss of RF communication with the mobile unit.

Optionally, at step 304, the base station may boost its transmitted power on compromised wireless channels to increase the likelihood that RF communication can be maintained with mobile units that are in the COMPROMISED state. It is possible, however, that RF communication can be maintained between the base station and affected mobile units without boosting power on the compromised wireless channels.

At step 306, the base station instructs mobile units on any impaired wireless channels to retune/handoff to an alternate wireless channel (e.g., unimpaired carrier/band); and at step 308, the base station starts a wait timer to await responses from the mobile units. The period of the wait timer may be predetermined or dynamically determined for different types or levels of RF signal interference. The wait timer allows for the base station to determine, based on the presence (or absence) of responses from the mobile units during a given time threshold, which mobile units have maintained RF communication with the base station during the interference.

Mobile units having successfully received the retune/handoff instruction will request a retune/handoff to an alternate wireless channel (e.g., carrier/band). If the base station receives the retune/handoff requests before expiration of the wait timer (determined at step 312), the base station at step 310 will service the retune/handoff requests by effecting a hard handoff to an alternate wireless channel (e.g., setting up a speech path to an unimpaired carrier/band and then tearing down the speech path to the comprised carrier/band) during the active call. The mobile units having successfully retuned during the active call are now returned to the CONNECTED call state. Mobile units not responding before expiration of the wait timer are considered to have lost RF communication. At step 314, the base station will end or suspend calls to mobile units not responding before expiration of the wait timer; and the call state of the mobile units may move to the SUSPENDED or IDLE state accordingly.

At step 316, the base station will direct any reconnect requests (i.e., for mobile units in the SUSPENDED state), as well as any new call originations or terminations (i.e., for mobile units in the IDLE state) to unimpaired wireless channels.

FIG. 4 is a flowchart showing a method for managing channel assignments for reconnections, new originations/terminations or hand-offs following incidents of wireless signal interference. The steps of FIG. 4 are implemented, where applicable, using stored software routines within base station 104, MSC 112 and/or mobile unit 102.

The method presumes at step 402, one or more incidents of jamming or other wireless signal interference is detected on an available wireless channel (e.g., carrier/band). Generally, detection of jamming or other interference at step 402 can mean that a channel impairment either exists or prospectively exists on a particular channel. The available wireless channel defines, for example, a carrier/band that is either supporting an active call or that will prospectively be assigned to support an active call. In one embodiment, the signal interference is detected by base station(s) of various cell/sector(s) in geographic proximity to source(s) of the interference (e.g., upon RF loading exceeding a system-defined threshold) and reports the incident to its MSC.

In one embodiment, the base station, MSC or other network element (not shown) maintains a record associated with various wireless channels to facilitate channel assignments for reconnections, new originations/terminations or hand-offs. Upon detection of the jamming or other wireless signal interference on a particular wireless channel (e.g., carrier/band) at step 402, the wireless channel is considered to be unstable and the record is modified, accordingly, to indicate instability or unavailability of that channel for new reconnections, new originations/terminations or hand-offs until such time as sufficient time has elapsed without any further incidents of jamming on that channel.

At step 404, the base station starts or resets a stability timer, to count-down a minimum waiting period following incidents of interference before affected channel(s) may be assigned for reconnections, new originations/terminations or hand-offs. The period of the stability timer may be predetermined or dynamically determined for different types or levels of RF signal interference.

Until such time as the stability timer elapses, determined at step 410, the base station at step 406 will direct reconnections, new originations/terminations or hand-offs to stable channels (e.g., carrier/bands that have not experienced incidents of jamming or other wireless signal interference or for which sufficient time has elapsed following an incident of signal interference to be assignable). If further incidents of jamming or other signal interference is detected during count-down of the stability timer, determined at step 408, the process returns to step 404 to reset the stability timer.

If and when the stability timer elapses (i.e, sufficient time has elapsed without further incidents of jamming or other interference), the affected wireless channel is considered to be stable and at step 412, the record is modified, accordingly, to indicate availability of that channel for new reconnections, new originations/terminations or hand-offs.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
detecting an incident of wireless signal interference that interferes with a wireless channel during an active call, yielding a compromised channel;
instructing mobile units tuned to the compromised channel to retune to a different channel; and
if a retune message is received from a mobile unit before expiration of a waiting period, performing a hand-off of the mobile unit to an alternate wireless channel.

2. The method of claim 1, wherein the step of performing a hand-off comprises establishing a new voice path to the alternate wireless channel and tearing down the voice path to the compromised channel while maintaining the active call.

3. The method of claim 1, further comprising ending the call if a retune message is not received before expiration of the waiting period.

4. The method of claim 1, further comprising maintaining call state information associated with one or more mobile units, the method comprising:
entering a connected call state for a mobile unit engaged in an active call;
entering a compromised call state for the mobile unit engaged in the active call if it encounters wireless signal interference yielding a compromised channel; and
re-entering the connected call state for the mobile unit if handoff to an alternate wireless channel is accomplished while maintaining the active call.

5. A method comprising:
detecting an incident of wireless signal interference corresponding to an available wireless channel;
responsive to detecting the interference, designating the channel as unavailable for a predetermined time period;
if the predetermined time period elapses without any further incidents of wireless signal interference corresponding to the channel, re-designating the channel as available.

6. The method of claim 5, wherein the step of designating the channel as unavailable renders the channel unassignable to support one or more of reconnections, new originations, terminations and hand-offs, until such time as the predetermined time period elapses without any further incidents of wireless signal interference corresponding to the channel.

7. The method of claim 5, further comprising:
until such time as the predetermined time period has elapsed without any further incidents of wireless signal interference corresponding to the channel, directing any reconnections, new originations, terminations and hand-offs to an alternate channel.

8. The method of claim 5, wherein the available wireless channel comprises a channel that is supporting an active call at the time of detecting the interference.

9. The method of claim 5, wherein the available wireless channel comprises a channel that is not supporting an active call at the time of detecting the interference.
